(19) United States
(12) Patent Application Publication
(10) Pub. No.: US 2012/0071368 A1
(43) Pub. Date: Mar. 22, 2012

(54) Drilling Fluid for Enhanced Rate of Penetration

(75) Inventor: Michael Fefer, Whitby (CA)

(73) Assignee: SUNCOR ENERGY INC., Calgary (CA)

(21) Appl. No.: 13/095,811

(22) Filed: Apr. 27, 2011

Related U.S. Application Data
(60) Provisional application No. 61/328,597, filed on Apr. 27, 2010.

(51) Int. Cl. C09K 8/035

(52) U.S. Cl. 507/103

(57) ABSTRACT

A drilling fluid is provided which results in an enhanced rate of penetration, and more particularly, a drilling mud composition is provided with a reduced ester content which maintains an enhanced rate of penetration.

### CROSS-REFERENCE TO RELATED APPLICATIONS

This application claims priority to U.S. provisional patent application Ser. No. 61/328,597, filed on Apr. 27, 2010, the disclosure of which is incorporated herein by reference in its entirety.

### FIELD OF THE INVENTION

The present invention relates to drilling fluids which result in an enhanced rate of penetration and more particularly to a drilling mud composition with a reduced ester content which maintains an enhanced rate of penetration.

### BACKGROUND OF THE INVENTION

Drilling fluids, also referred to as drilling muds, serve a number of purposes in a wellbore. The fluids suspend and remove cuttings which are created at the drill bit, act as lubricants between the formation and the drill bit which typically enhance the rate of penetration (ROP) through the formation, aid in controlling formation pressures and assist in maintaining wellbore stability, among many other uses.

Many difference drilling mud formulations are known in the industry. Drilling muds are either water based, oil based or can be invert emulsion muds, wherein the oil phase is typically the continuous phase, Generally, a number of additives are added to the base fluid to improve the rheology of the fluid, prevent corrosion of wellbore tubulars and equipment and to enhance the ROP. There has also been great interest in the industry to formulate fluids which are less environmentally unacceptable and which improve the economics of drilling.

In the drilling industry there is a direct relationship between drilling time and expenditure. Enhancing the ROP helps to reduce drilling time and drilling costs. Further, formulations which utilize less expensive components may be of great interest provided they meet other, sometimes competing, objectives such as environmental acceptability.

In an effort to increase environmental acceptability, drilling mud formulations are known which utilize large amounts of ester-based fluids or olefins as the base fluid for the drilling mud.

One known formulation adds esters to drilling fluids, particularly olefin isomer products resulting from a double bond isomerization treatment of waxy olefins, alone or in combination with C₁₂ to C₁₈ paraffinic hydrocarbons for enhanced biodegradability, viscosity and other specifications. This formulation does not specify the amount of ester to be added.

Another known formulation adds ester to a mineral hydrocarbon oil being substantially free of aromatics, having a paraffin content of not more than 10% and an isoparaffin content not less then 36%. This formulation adds ester at amounts less than 5% results in a fluid which has reduced and unacceptable biodegradability, which is consistent with conventional thinking in the industry. Generally one of skill in the art to this date believes that the relationship between the addition of ester to a drilling fluid and positive effects derived therefrom is linear—the more ester added, the greater the ROP and the more biodegradable the fluid is.

Another known formulation adds ester to a water-based drilling fluid in amounts as low as 0.1% to about 3% as a lubricant for enhancing ROP. The addition of the ester to a water-based fluid must be sufficiently low so as to keep from shifting the base fluid from a water-based fluid to an oil-based fluid. The particular esters in this formulation are a very specific group of low quality esters prepared as reaction products of a glycerol component, a fatty acid component and a carboxylic acid component. The resulting ester-containing lubricating composition is environmentally acceptable for use in marine environments.

Typically, esters are added to conventional drilling fluids in amounts greater than 20-30% and may be utilized entirely as 100% of the base fluid. Conventional drilling fluids also utilize more expensive, more environmentally acceptable base fluids rather than less expensive fluids which contain higher paraffin concentrations.

There is interest in industry to find ways to utilize less expensive paraffin-containing base fluids while at the same time reducing the amount of expensive additives, such as esters, olefins and the like.

### SUMMARY OF THE INVENTION

In one aspect of the present invention there is provided a drilling composition. The drilling composition may include:
I) an organic phase comprising components
   i. from about 20 wt. % to about 99.999 wt. %, based on the total weight of components i. and ii., of at least one linear or branched, cyclic or non-cyclic, saturated hydrocarbon,
   ii. from about 0.001 wt. % to about 25 wt. %, based on the total weight of components i. and ii., of at least one ester,
II) from 0 to about 50 wt. %, based on the total weight of the composition, of water or aqueous phase,
III) from 0 to about 60 wt. %, based on the total weight of the composition, of at least one additive,

wherein the sum of the weight components I) to III) is 100 wt. %.

In a further aspect of the composition, the at least one hydrocarbon may be at least one alkane.

In a further aspect of the composition, the at least one ester may be at least one ester selected from the group consisting of esters formed from at least one C₁ to C₂₄ monocarboxylic acid with at least one mono-functional alcohol.

In a further aspect of the present invention, the composition may be in the form of an emulsion, preferably in the form of a nanoemulsion or a microemulsion, preferably in the form of a water-in-oil emulsion with droplet sizes in the range from about 5 nm to about 1000 μm.

In a further aspect of the composition, the at least one additive may be at least one additive selected from the group consisting of weighting agents, clays, fluid loss additives, pH modifiers, viscosity modifiers, filtration control agents, emulsifiers, salts, wetting agents, dispersants.

In a further aspect of the composition, the at least one ester may have a carbon chain distribution of the acid-derived component determined according to ISO 5508 with carbon numbers in the ranges of from 0 to 2.00% C₆, from 3.00% to 10.00% C₈, from 3.00% to 10.00% C₁₀, from 50.00% to 94.00% C₁₂, from 0 to 25.00% C₁₄, from 0 to 5.00% C₁₆ and from 0 to 1.00% C₁₈.

In yet a further aspect of the composition, the at least one ester may have a carbon chain distribution of the acid-derived component determined according to ISO 5508 with carbon numbers in the ranges of from 0 to 2.00% C₆, from 0 to 10.00% C₈, from 0 to 10.00% C₁₀, from 50.00% to 95.00% C₁₂, from 5.00% to 35.00% C₁₄, from 0 to 5.00% C₁₆ and from 0 to 1.00% C₁₈.

In another aspect of the present invention, there is provided a process for preparation of a drilling composition. The process may include the steps:
a) providing as component i. from about 20 wt. % to about 99.999 wt. %, based on the total amount of i. and ii., of at least one linear or branched, cyclic or non-cyclic, saturated hydrocarbon,
b) providing as component ii. from about 0.001 wt. % to about 25 wt. %, based on the total amount of i. and ii., of at least one ester,
wherein the sum of the weight amounts provided in a) and b) is 100 wt. %,
c) combining the at least one hydrocarbon and the at least one ester.

In another aspect of the present invention, there is provided a process for preparation of a drilling composition. The process may include the steps:
A) preparation of an organic phase comprising components
   i. from about 20 wt. % to about 99.999 wt. %, based on the total weight of components i. and ii., of at least one linear or branched, cyclic or non-cyclic, saturated hydrocarbon,
   ii. from about 0.001 wt. % to about 25 wt. %, based on the total weight of components i. and ii., of at least one ester,
B) preparation of an aqueous phase comprising from about 50 wt. % to 100 wt. % water, based on the total amount of aqueous phase,
C) combination of the organic phase prepared in step A) with from 0 to 50 wt. %, based on the total weight of the composition, of the aqueous phase prepared in step B), and
D) combination of at least one of the organic phase, the aqueous phase and the combination of the organic phase and the aqueous phase with from 0 to about 60 wt. %, based on the total weight of the composition, of at least one additive.

The process may further include the step
E) homogenisation.

In a further aspect of the process, the composition at the end of at least one of steps C), D) and E) may be in the form of an emulsion.

The emulsion may be a nanoemulsion or a microemulsion with droplet sizes in the range from 5 nm to 1000 μm.

In a further aspect of the process, the at least one ester may be at least one ester selected from the group consisting of esters formed from at least one C₁ to C₂₄ monocarboxylic acid with at least one mono functional alcohol.

In a further aspect of the process, the at least one ester may have a carbon chain distribution of the acid-derived component determined according to ISO 5508 with carbon numbers in the ranges of from 0 to 2.00% C₆, from 3.00% to 10.00% C₈, from 3.00% to 10.00% C₁₀, from 50.00% to 94.00% C₁₂, from 0 to 25.00% C₁₄, from 0 to 5.00% C₁₆ and from 0 to 1.00% C₁₈.

In a further aspect of the process, the at least one ester may have a carbon chain distribution of the acid-derived component determined according to ISO 5508 with carbon numbers in the ranges of from 0 to 2.00% C₆, from 0 to 10.00% C₈, from 0 to 10.00% C₁₀, from 50.00% to 95.00% C₁₂, from 5.00% to 35.00% C₁₄, from 0 to 5.00% C₁₆ and from 0 to 1.00% C₁₈.

The process may further include a drilling composition obtainable by a process having at least one of the properties:
γ1) a plastic viscosity measured at 50° C. according to the herein described test method in the range from 15 to 75 mPa·s;
γ2) a yield point measured at 50° C. according to the herein described test method in the range from 5 to 45 lb/100 ft2 (2.4 to 21.6 Pa);
γ3) a gel strength measured at 50° C. according to the herein described test method in the range from 4 to 25 lb/100 ft2 (1.9 to 12 Pa).

In a further aspect of the present invention there may be provided a process for making a borehole. The process may include the steps:
a1) providing a composition;
a2) drilling a hole in a subterranean formation;
a3) circulating the composition provided in a1) at least partially in the hole at least partially while drilling.

In a further aspect of the present invention there may be provided a process for conveying cuttings from a hole drilled in a subterranean formation. The process may include the steps:
b1) providing a composition;
b2) circulating the composition provided in b1) at least partially in the hole.

In a further aspect of the process, the composition may be circulated at least partially while drilling the hole.

In a further aspect of the present invention there may be provided a process for treatment of a drill head. The process may include the steps:
c1) providing a composition;
c2) circulating the composition provided in c1) at least partially through the drill head at least partially while the drill head is operated in a subterranean formation.

The treatment may be at least one of cleaning, cooling and lubrication.

In a further aspect of the present invention, there is provided a process for production of at least one of oil and gas. The process may include steps:
d1) providing a composition;
d2) drilling at least one hole in a subterranean formation while at least partially circulating the composition provided in d1) at least partially in the hole;
d3) obtaining at least one of oil and gas from the subterranean formation at least partially by means of the at least one hole drilled in d2);
d4) optionally, subjecting the at least one of oil and gas to at least one processing step selected from purifying, refining and treating.

In another aspect of the present invention there is provided a drilling fluid comprising an organic phase comprising between about 20 wt. % to about 95 wt. % of at least one saturated hydrocarbon based on the total weight of the organic phase; and about 5 wt. % of ester based on the total weight of the organic phase.

In another aspect of the present invention there is provided a drilling fluid comprising an organic phase comprising a base composed of at least one saturated hydrocarbon; and an ester present in sufficiently low range amount with respect to the total weight of the organic phase to allow an increased rate of penetration (ROP) of the drilling fluid compared to a corresponding identical fluid with a higher ester content.

In some preferred aspects, the low range of ester content has a lower threshold of about 0.01 wt %, 0.5 wt %, 1 wt %, 1.5 wt %, 2 wt %, 2.5 wt %, 3 wt %, 3.5 wt %, 4 wt %, 4.5 wt % or 5 wt %; and an upper threshold of about 9.9 wt %, 9.5 wt %, 9 wt %, 8.5 wt %, 8 wt %, 7.5 wt %, 7 wt %, 6.5 wt %, 6 wt %, 5.5 wt % or 5 wt %.

In another aspect of the present invention there is provided a method of achieving increased rate of penetration (ROP) of a drilling fluid, comprising adding to an organic phase comprising a base composed of saturated hydrocarbons a low amount of ester sufficient to increase the ROP of the drilling fluid above that of a corresponding fluid with a higher ester content.

### BRIEF DESCRIPTION OF THE DRAWINGS

FIG. 1 presents a graph of rate of penetration vs. % ester added, in accordance with an embodiment of the present invention.

FIG. 2 depicts a Lueders limestone/Mancos shale test specimen.

FIG. 3 presents a graph of rate of penetration per revolution vs. fluid performance in Mancos shale with 500 lbs. force.

FIG. 4 presents a graph of rate of penetration per revolution vs. fluid performance in Mancos shale with 300 lbs. force.

FIG. 5 presents a graph of rate of penetration per revolution vs. fluid performance in Lueders limestone with 300 lbs. force.

FIG. 6 depicts a chart of wellbore to formation fluid transfer.

### DETAILED DESCRIPTION

Applicant has found surprisingly that small amounts of ester added to paraffinic base fluids results in an enhanced ROP of substantially the same magnitude as that previously thought only to be achieved through the addition of larger amounts of ester.

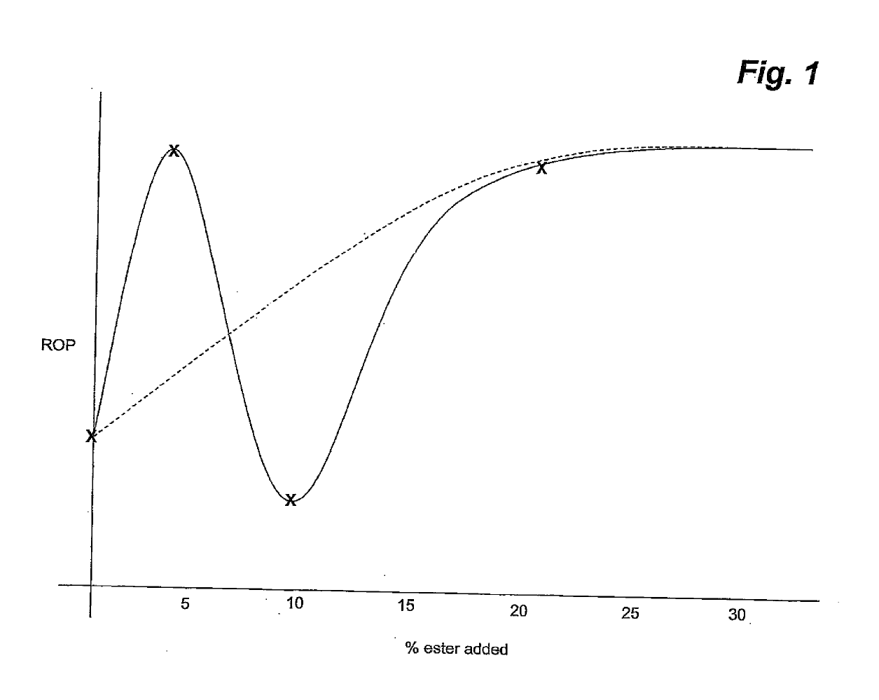

As shown in FIG. 1, Applicant has noted that there is a significant increase in ROP when about 5% or less ester is added to a paraffinic base fluid. Further increase in the amount of ester between 5% to about 10% resulted in a drop in the ROP. Thereafter, further increases in the ester from 10% results in what appears to be a somewhat linear increase in ROP with increasing amounts of ester added to the base fluid, which is inconsistent with conventional understanding. The observed phenomena with embodiments of the invention is in direct contradistinction to the conventional understanding which has been that there was a linear relationship across the entire range of ester, with little to no enhancement in ROP until significantly higher amounts of ester, such as about 20-30% or greater was added.

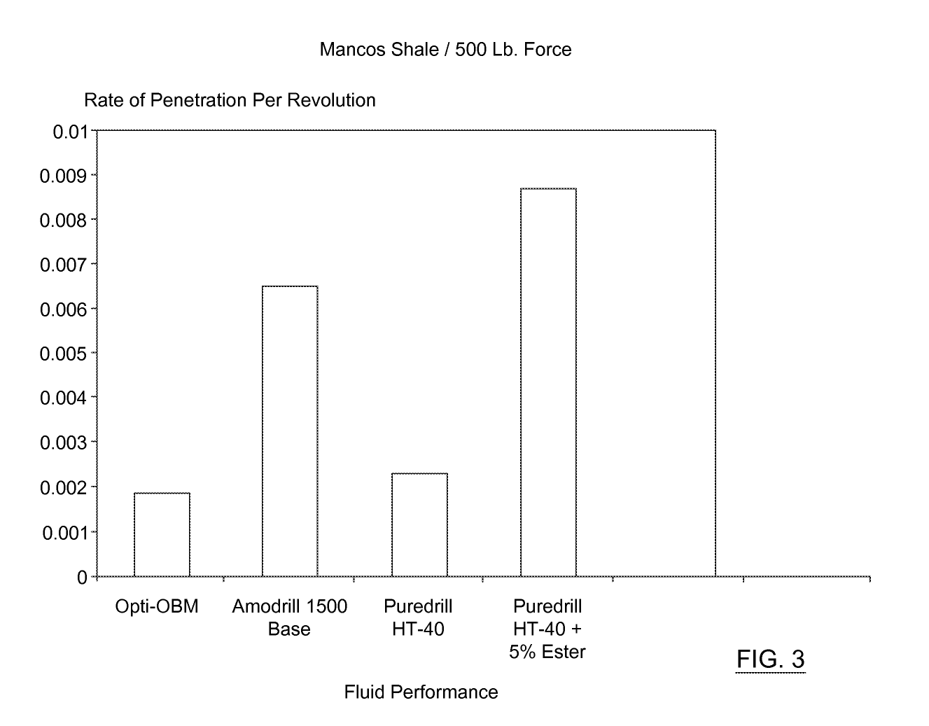

As shown in FIGS. 3-5, Applicant has succeeded in increasing the ROP by modifying the continuous phase of drilling fluids. The addition of a very small amount of ester, about 5% or less, to a paraffinic fluid stimulated a very significant increase in the ROP. The addition of 10% ester however showed a deterioration in the ROP compared to drilling mud alone, without the addition of ester. A similarly large increase in ROP associated with the addition of esters to a variety of drilling fluids, has previously only been observed when ester was added at significantly higher amounts, such as at amounts greater than 20%, for example to C₁₆-C₁₈ internal olefins.

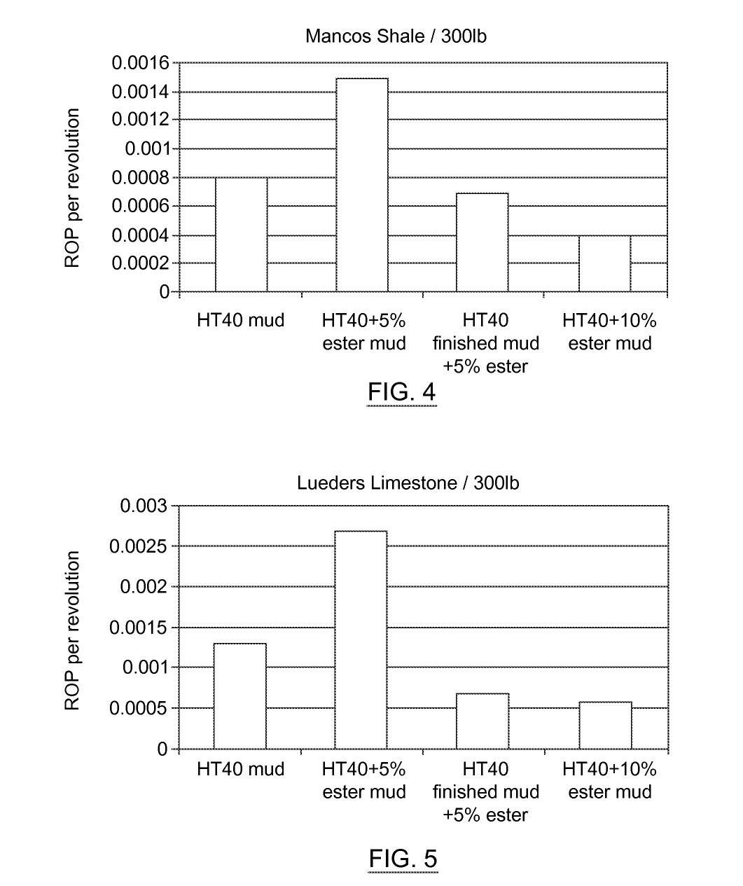

Further Applicant has found that the order of addition of the constituents of the drilling mud, particularly the ester, is significant. Ester is added first to the base oil. As shown in FIGS. 4 and 5, the addition of 5% ester to a finished drilling mud did not achieve the same enhanced ROP observed when the ester was added first to the base oil; only after which additional, conventional additives were blended.

Applicant believes that while there are limited esters which are suitable for use in a wellbore, any of these conventionally utilized esters could be used according to embodiments of the invention. One exemplary ester blend is OMC 586™ available from Cognis Oleochemicals GmbH, Germany. Additional information regarding this ester is appended hereto in Appendix A.

Other suitable esters are isopropyl esters of saturated straight chain carboxylic acids such as available from Inolex Chemical Company, Philadelphia, Pa., USA. The isopropyl esters are fatty acid esters derived from the condensation of isopropanol with saturated linear fatty acids of C₁₂, C₁₄ and C₁₆ chain length, respectively, the fatty acid moieties being normally derived from palm oil, palm kernel oil, or coconut oil.

Applicant has found that the addition of 5% fatty acid ester (OMC 586) blended with Petro-Canada PUREDRILL® HT40, a substantially paraffinic base fluid, resulted in enhanced ROP when the ester/HT40 mixtures were used as the base fluid to formulate both an oil-based drilling mud and an invert emulsion drill mud.

One formulation, according to an embodiment of the invention, used to make an invert emulsion drill mud is as follows:

Base Fluid:

95% PUREDRILL®HT40*+5% OMC 586™/water ratio=85/15

Additives:

Potassium Acetate: 30% wt

TRUVIS®** (Organophilic clay, viscosifier): 12 kg/m³

Lime (Calcium hydroxide): 15 kg/m³

VERSAMUL®*** (emulsifier): 15 kg/m³

VERSACOAT®*** (emulsifiers and gelling agent): 9 kg/m³

* available from Petro-Canada, Calgary, Alberta, Canada

** available from International Drilling Fluids Corp. Calgary, Alberta, Canada

*** available from M-I Drilling Fluids LLC, Houston, Tex. USA

PUREDRILL® HT40 is a substantially paraffinic drilling fluid made through high pressure (˜300 psig), high temperature (˜400° C.) distillate hydrocracking The carbon number range of PUREDRILL® HT40 spans C₁₂-C₂₁ and contains a paraffin content >95 wt %.

OMC 586™ is substantially a C₈₋₁₄-2 ethylhexylester blend.

### EXAMPLES

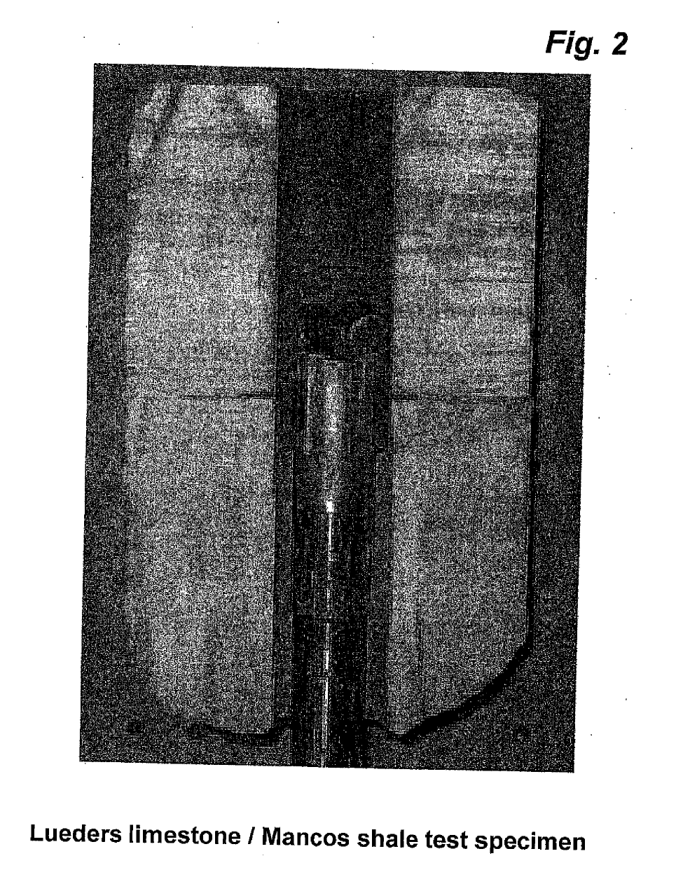

ROP testing was carried out using a limestone/shale rock sandwich sample, as shown in FIG. 2, drilled in-situ using a diamond MicroDrill. Tests were conducted at 120° F. fluid/sample temperature. The limestone/shale samples were drilled using a consistent revolution per minute (rpm) of about 61 rpm and a flow rate of drilling mud of about 1 gallon per minute.

### Example 1

As shown in FIG. 3, in the all-oil invert mud system, as previously described, Applicant has found that the addition of 5% ester to the PUREDRILL® HT40 based mud resulted in at least a doubling of the ROP when compared to PUREDRILL® HT40 without the ester. The embodiment tested was also found to out-perform diesel (Opti-OBM available from Newpark Drilling Fluids LLC of Houston Tex., USA) and a synthetic linear alpha olefin (LAO)-based mud (AMODRILL® 1500, available from Innovene, North America, League City, Tex., USA))

### Example 2

As shown in FIGS. 4 and 5 and in a second example using the invert mud system as previously described, Applicant reproduced the at least a doubling of ROP with the addition of 5% ester.

Totally unexpectedly, Applicant also found that the order of addition of the ester affected performance.

As shown in FIGS. 4 and 5, the addition of 5% raw ester to a finished invert mud system that did not contain any ester, did not demonstrate the beneficial impact on ROP seen when the ester was incorporated during the initial blending.

Applicant further noted that the addition of ester in amounts exceeding 5% and particularly at 10% did not further improve the ROP as expected with conventional understanding. Instead the addition of 10% ester to the invert mud system resulting in a deterioration of ROP, the ROP being lower than that of the base drilling mud without the ester. As the amount of ester approached conventional amounts, being greater than 20%, the ROP once again increased.

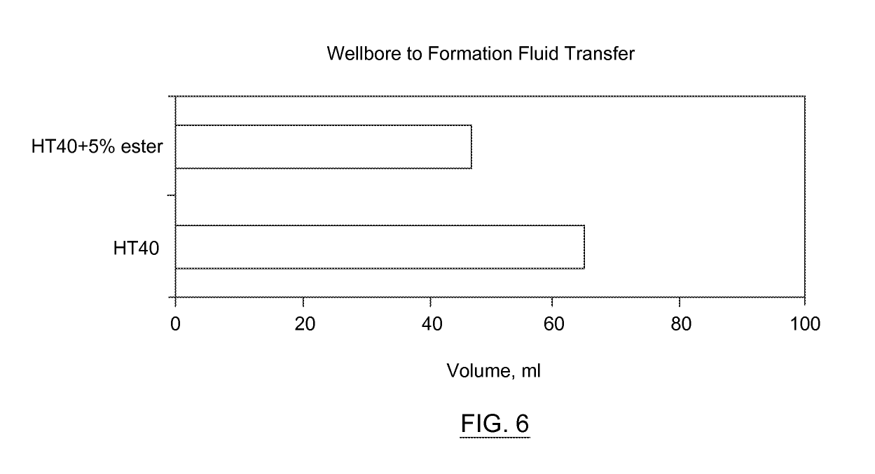

As shown in FIG. 6, an additional benefit to the addition of ester in an amount of 5% or less is a reduced fluid loss from the wellbore to the formation.

Applicant has described in Appendix B additional embodiments of the invention including a description of conventional additives which may be added to the ester/base oil mixture.

Applicant believes that the advantages of a higher than expected ROP with lower than conventional amounts of ester, using embodiments of the invention, result in significant overall savings to the industry. Assuming a cost of $1.85 (CDN) per litre for ester and cost of $0.85 (CDN) for base oil and a use of 5% ester according to an embodiment of the invention, a minimum increase of about 1.4% in ROP is sufficient to break even when compared to base oil cost without ester addition. In a wellbore drilled to 15327 feet as a projected ROP increase of about 25% using this embodiment of the invention, Applicant anticipates a savings of about $250,000 (CDN) for the well. Clearly, the addition of only 5% ester is a significant saving compared to a conventional use of ester at 20-30% or greater.

Appendix A

Exemplary Ester Blends

At least one ester added to the organic phase of a drilling fluid is selected from the group consisting of esters formed from at least one C₁ to C₂₄ monocarboxylic acid with at least one monofunctional alcohol.

The at least one ester can be selected from natural and synthetic esters, or mixtures of at least two thereof. By natural esters are understood esters which themselves occur naturally, for example esters of plant or animal origin, as well as esters formed from at least one naturally occurring carboxylic acid and/or at least one naturally occurring alcohol.

According to one embodiment the at least one ester has solidification values (pour point and setting point) below −10° C. and more preferably below −15° C. The at least one ester is fluid and pumpable at temperatures at least in the range from about −10° C. to about 5° C., preferably at temperatures in the range from about 0° C. to about 5° C., as well as above 5° C. At the same time, particularly for safety reasons, the flash points of these esters are as high as possible. In one embodiment the at least one ester has a flash point measured according to ASTM D93 above about 80° C., preferably above about 100° C., more preferably above about 120° C., yet more preferably above about 150° C., even more preferably above about 160° C.

The esters advantageously have viscosity values (measured according to ASTM D2983, using a Brookfield RVT viscometer) at temperatures of 0° C. to 5° C. of not more than 50 mPa·s and preferably of at most 45 mPa·s or lower. Exemplary esters for use in embodiments of the invention are described in DE 39 07 391 A1, DE 39 07 392 A1, DE 38 42 703 A1 and DE 38 42 659 A1, whose disclosure concerning esters is hereby incorporated by reference into the present disclosure.

When selecting the appropriate alcohol components for the ester the following addition considerations are taken into account: When the ester is used in practice, it is not always possible to exclude partial saponification of the ester. Free alcohols form, in addition to the free carboxylic acids thus formed or carboxylic acid salts forming together with the alkali reserves. They should be selected such that even after partial hydrolysis operational conditions are ensured which are ecologically and toxicologically harmless, with inhalation-toxicological considerations in particular being taken into account. The alcohols used for the ester formation in particular possess such a low volatility that in the free state under conditions to be expected in practice, they do not result in any nuisance on the working platform.

The at least one ester according to embodiments of the invention can be described by means of the following sub-classes.

In a first sub-class of the at least one ester may be selected from C₁-C₅ monocarboxylic acid esters. The esters of C₁-C₅ monocarboxylic acids are reaction products of monofunctional alcohols, i.e. alcohols with one hydroxy group. In this case the carbon number of the alcohol is at least 6, but is preferably higher, for example at least 8 to 10 carbon atoms.

In this sub-class esters used according to embodiments of the invention are derived from monocarboxylic acids with 2 to 4 carbon atoms, with acetic acid being particularly preferred as the ester-forming component.

For this sub-class of esters based on very short-chain (C₁-C₅) monocarboxylic acids, embodiments of the invention use comparatively long-chain monofunctional alcohols, preferably with up to 24 carbon atoms, preferably with from 6 to 24, more preferably from 8 to 24 carbon atoms, so as to sufficiently reduce the volatility of the ester. Even after partial hydrolysis in use, the drilling fluids are ecologically and toxicologically harmless, particularly inhalation-toxicologically harmless under working conditions. In practical use it is assumed that the at least slightly heated drilling fluid is re-circulated and freed, particularly by screening, from the drill cuttings it takes up. With progressive ageing and the partial hydrolysis thus caused, problems can arise not only from the formation of free fatty acids and their salts, but the freed alcohol components can also cause difficulties in practical operation. The alcohol content is typically taken into consideration if alcohol vapor nuisance is to be expected as a result of its volatility and the required operation temperatures.

Suitable alcohols, particularly suitable monofunctional alcohols can be of natural and/or synthetic origin. Straight-chain and/or branched alcohols can be used. If monofunctional alcohols of natural and/or synthetic origin which are predominantly aliphatic saturated are present in the esters used, then such alcohols with 8 to 15 carbon atoms are used for ester formation. The vapor pressure is so low in the operational conditions occurring in practice that the problems related to vapor nuisance do not apply. Olefin mono- and/or polyunsaturated alcohols are also suitable, such as can be obtained, for example, by the selective reduction of naturally occurring unsaturated carboxylic acids, for example fatty acids, or their esters. The alcohols can, however, also be of synthetic origin.

Esters of monofunctional alcohols for use in embodiments of the invention are not, however, limited to this carbon number range. Higher monofunctional alcohols can also be considered, of which the esters with the carboxylic acids of medium chain length yield oils or oil components with usable rheological properties. Particularly to be considered here are olefin mono- and/or poly-unsaturated alcohols which can, for example, have up to 24 carbon atoms or even higher numbers of carbon atoms. Alcohols of this type can be obtained in particular by the selective reduction of corresponding natural fatty acids.

In a second sub-class of the at least one ester the esters, fluid at room temperature and having flash points above 80° C., are derived from monocarboxylic acids of synthetic and/or natural origin with 6 to 11 carbon atoms and monofunctional alcohols.

In this embodiment it alcohol components are used in the esters which even after a partial ester cleavage are ecologically and toxicologically harmless in practical use, in particular taking into account in this regard the inhalation-toxicological problems which can become significant when dealing with the oil-base composition in practical use.

In this sub-class the esters are based, on the carboxylic acid side, on synthetic and/or natural monocarboxylic acids with 6 to 11 carbon atoms, which can be straight-chain and/or branched. Straight-chain and as a rule even-numbered carboxylic acids in this range can be derived particularly from oils or fats of natural origin and are known to form the so-called pre-fatty-acids with from 6 to 10 carbon atoms. Synthetic carboxylic acids of this type are also easily obtainable, for example, by the oxidation of Ziegler alcohols. Branched, or mixtures of branched and straight-chain carboxylic acids in this range can be obtained from numerous processes in the petrochemical industry. Esters of this type preferably contain at least 6 and better still at least 7 carbon atoms in the alcohol component. With this comparatively high lower limit value for the alcohol component, it is possible to ensure that in practical use, even after a partial ester cleavage, toxicological and particularly inhalation-toxicological problems can be overcome by simple means. In embodiments of the invention the alcohols used are those having up to 24 or more carbon atoms and the C₈ to C₁₅ alcohols mentioned above in connection with the first sub-class of the at least one ester.

In a third sub-class of the at least one ester the esters are esters of saturated aliphatic C₁₂-C₁₆ monocarboxylic acids and monofunctional C₂-C₁₂, preferably C₄-C₁₂ alcohols or mixtures thereof.

The presence of saturated carboxylic acids containing less than 16 carbon atoms and, more especially, from 12 to 14 carbon atoms are used according to embodiments of the invention. In small quantities, the contents of such lower, fully saturated fatty acids often present in natural starting materials are frequently valuable mixture components. Their esters are not vulnerable to oxidation under practical in-use conditions and their rheological properties allow them to replace, to a certain extent, pure hydrocarbon oils in practice.

In one embodiment using the third sub-class of the at least one ester at least the predominant part, i.e. at least 50%, preferably at least 60%, of the ester used is based on saturated aliphatic C₁₂-C₁₄ monocarboxylic acids.

The esters used in accordance with the third sub-class of the at least one ester can be derived from either straight chain or branched hydrocarbon chains. In one embodiment esters of straight chain acids, in particular the esters of saturated C₁₂₋₁₆ and more especially C₁₂₋₁₄ monocarboxylic acids and monofunctional alcohols having the C chain lengths defined in accordance with this sub-class are used. These can form esters which show adequate rheological properties, even down to temperatures in the range of from 0 to 5° C., and in particular are flowable and pumpable in that temperature range. In the context of this sub-class esters are saturated compounds which have a Brookfield (RVT) viscosity, measured as described above, at a temperature of 0 to 5° C., of no more than 50 mPa·s and preferably of no more than 40 mPa·s. By selecting suitable components for the ester-forming reaction, it is possible to adjust the viscosity at temperatures in the above-mentioned range to values of at most 30 mPa·s, for example in the range of from 10 to 20 mPa·s. It is clear that this affords important advantages for offshore drilling where the surrounding water can have very low temperatures.

The alcohol components of the esters or ester mixtures according to this embodiment of the invention are derived from straight-chain and/or branched-chain saturated alcohols, preferably alcohols containing at least 3 carbon atoms and, more especially, to alcohols containing up to about 10 carbon atoms, whereby alcohols with 4, 5, 6, 7, 8, or 9 carbon atoms can also be used. The alcohols can also be of natural origin, in which case they have normally been obtained from the corresponding carboxylic acids or their esters by hydrogenating reduction. However, the invention is by no means limited to starting materials of natural origin. Both on the monoalcohol side and on the monocarboxylic acid side, the starting materials of natural origin may be partly or completely replaced by corresponding components of synthetic origin. Typical examples of alcohols are the corresponding oxo alcohols (branched alcohols) and the linear alcohols obtained by the Ziegler process. Similarly, monocarboxylic acid components present in particular in carboxylic acid mixtures can be derived from petrochemical synthesis.

The esters used in accordance with this aspect of the composition based on selected individual components or on ester mixtures have solidification values (pour point and setting point) below −10° C. and more especially below −15° C. Despite this high mobility at low temperatures, the molecular size of the ester in accordance with embodiments of the invention ensures that the flash points of the esters are sufficiently high, being at least 80° C., but generally exceeding a temperature limit of about 100° C. Esters having flash points above 150° C. to 160° C. are preferred. It is possible to produce esters of the described types which have flash points of 185° C. or higher.

In another embodiment using esters of the third sub-class, the esters are derived from materials of predominantly vegetable origin. Carboxylic acids or carboxylic acid mixtures predominantly containing saturated monocarboxylic acids within the stated range can be obtained, for example, from renewable triglycerides, such as coconut oil, palm kernel oil and/or babassu oil. Fatty acid mixtures of this origin normally contain a limited quantity of lower fatty acids (C₆₋₁₀) of generally at most about 15%. Their content of C₁₂₋₁₄ acids is by far predominant, generally making up at least 50% and normally 60% or more of the carboxylic acid mixture. The small remainder consists of higher fatty acids, with unsaturated components playing a considerable role. Accordingly, carboxylic acid mixtures of this type, by virtue of their natural structure, readily lead to materials having satisfactory rheological properties.

In a fourth sub-class of the at least one ester esters of monofunctional C₂-C₁₂ alcohols (alkanols) and olefinically mono- and/or polyunsaturated C₁₆-C₂₄ monocarboxylic acids or mixtures thereof with small quantities of other, more especially saturated monocarboxylic acids are used.

The esters according to the fourth sub-class may be assigned to the class of reaction products of monofunctional carboxylic acids, preferably C₁₆-C₂₄ carboxylic acids, with monofunctional alcohols. The carboxylic acids may be derived from unbranched or branched hydrocarbon chains, preferably linear chains. Monocarboxylic acids of this type and of the C₁₆-C₂₄ range and esters thereof are unsuitable as predominantly saturated hydrocarbon compounds due to their comparatively high solidification points. Even then, however, esters of this type are flowable and pumpable down to temperatures of 0° C. to 5° C. providing an adequate level of olefinically unsaturated ester constituents is provided. In this sub-class therefore, esters of the described type of which more than 70% by weight and preferably more than 80% by weight are derived from olefinically unsaturated C₁₆-C₂₄ carboxylic acids are used. In embodiments of the invention natural starting materials are carboxylic acid mixtures which contain at least 90% by weight olefinically unsaturated carboxylic acids in the above C range. The unsaturated carboxylic acids may be mono- and/or polyolefinically unsaturated. Where carboxylic acids or carboxylic acid mixtures of natural origin are used, the double ethylenic double bond in particular and, to a lesser extent, even a triple ethylenic double bond per carboxylic acid molecule plays a role in addition to a single ethylenic double bond in the molecule.

In conjunction with the choice of esters of monofunctional reactants in accordance with the fourth sub-class of the at least one ester, the choice of such a comparatively highly unsaturated carboxylic acid component in the esters ensures that the esters, and invert emulsions comprising them, show the rheological properties required in practice, particularly at relatively low temperatures. The comparatively highly unsaturated esters containing 16 to 24 carbon atoms in the monocarboxylic acid component, which are used in accordance with this embodiment of the invention, have solidification points (pour point according to ASTM D97 and setting point) below −10° C. and more especially below −15° C. Despite this high mobility at low temperatures, the molecular size of the ester ensures that the flashpoints of the esters are sufficiently high, being at least 80° C., and generally exceeding a temperature limit of approximately 100° C. Esters having flashpoints above 160° C. are preferred. Esters of the described type showing high mobility, even at low temperatures, and having flashpoints of 185° C. or higher can be produced without difficulty by processes known to the skilled person.

In conjunction with these high flashpoints determined by the size of the molecule, it is possible at the same time to ensure that the viscosity values are within the required limits. Thus, esters of the type described for this embodiment show a viscosity (measured with a Brookfield RVT viscometer as above) at a temperature of 0° C. to 5° C. of not more than 55 mPa·s and preferably of at most 45 mPa·s or lower. It is possible to adjust values of 30 or even higher, for example in the range of from 20 to 25 mPa·s, at temperatures in the range indicated.

Among the unsaturated esters suitable for use in accordance with this fourth sub-class of the at least one ester, there are two preferred types of ester.

The first of these preferred types of ester is based on unsaturated C₁₆-C₂₄ monocarboxylic acids of which no more than about 35% by weight are diolefinically and, optionally, polyolefinically unsaturated. In their case, therefore, the content of di-and polyunsaturated carboxylic acid residues in the ester is comparatively limited. Within this sub-class it is preferred that at least about 60% by weight of the carboxylic acid residues are monoolefinically unsaturated.

The second preferred type of ester is derived from C₁₆-C₂₄ unsaturated monocarboxylic acid mixtures of which more than 45% by weight and preferably more than 55% by weight are derived from diolefinically and/or polyolefinically unsaturated acids within the above C range.

Preferred monoethylenically unsaturated carboxylic acids within the above carbon range are hexadecenoic acids (palmitoleic acid (C₁₆)), oleic acid (C₁₈), the related recinoleic acid (C₁₈) and erucic acid (C₂₂). A preferred di-unsaturated carboxylic acid within the range in question here is linoleic acid (C₁₈) while a preferred triethylenically unsaturated carboxylic acid is linolenic acid (C₁₈).

Selected individual esters formed from an unsaturated monocarboxylic acid and a monoalcohol can be used as the ester in accordance with this fourth sub-class of the at least one ester of component ii. of the composition of the invention. One example of such esters is given by the esters of oleic acid, for example of the oleic acid isobutyl ester type. So far as the rheology of the system is concerned and/or for reasons of availability, it is frequently desirable to use esters from acid mixtures. This is preferred so far as meeting the preferred specifications of the esters according to this aspect of the invention is concerned. This can also be preferred for all embodiments of the ester in the composition according to the invention, not only for this sub-class.

As already mentioned, the first of these two types is distinguished by the fact that its content of di-unsaturated and polyunsaturated acids is limited and does not exceed about 35% by weight. Vegetable oils of natural origin, of which the hydrolysis or transesterification gives mixtures of carboxylic acids or carboxylic acid esters of the type required here, are for example palm oil, peanut oil, castor oil and, in particular, rapeseed oil. Suitable rapeseed oils are both traditional types of high erucic acid content and also the more modern types of reduced erucic acid content and increased oleic acid content.

Esters of the first type according to this sub-class have the advantage that problems possibly arising from the lack of stability to oxidation are reduced. In practice, the drilling composition is continuously pump-circulated and, in the process, is brought constantly into contact with atmospheric oxygen, often over a large area and at least slightly elevated temperatures, for the purpose of separating out the rock cuttings brought up, for example by sieving.

However, carboxylic acid mixtures of the second type are also of practical significance for use in accordance with the invention. This is attributable in part to their broad accessibility from natural fats of animal and/or vegetable origin. Examples of oils which have a high content of C₁₆₋₁₈ or C₁₆₋₂₂ carboxylic acids and which, at the same time, contain at least about 45% of at least diethylenically unsaturated carboxylic acids are cottonseed oil, soybean oil, sunflower oil and linseed oil. The tall oil acids isolated during the recovery of cellulose also fall within this range. However, starting materials of the last type are generally distinguished by more or less large additional contents of resin constituents. A typical animal starting material for the production of corresponding carboxylic acid mixtures is fish oil, particularly herring oil.

The alcohol components of the esters or ester mixtures according to this fourth subclass are preferably derived from straight chain and/or branched-chain saturated alcohols, preferably alcohols containing at least four carbon atoms and, more preferably alcohols containing up to about ten carbon atoms, as described above. The alcohols can also be of natural origin, in which case they have normally been obtained from the corresponding carboxylic acids or their esters by hydrogenating reduction, or they can be of synthetic origin.

Esters which are used according to embodiments of the invention are based on C₈-C₁₄ fatty acids or difatty acids thereof, or on C₈-C₁₀ or C₁₂-C₁₄ fatty acids or difatty acids thereof, of which C₈-C₁₄ fatty acids or C₁₂-C₁₄ fatty acids are preferred. Particularly preferred esters are based on C₈ to C₁₄, C₈ to C₁₀ and/or C₁₂ to C₁₄ fatty acids, esterified with a branched alcohol, preferably with a branched C₄ to C₁₂ alcohol, yet more preferably with a branched C₆-C₁₀ alcohol, yet more preferably with a branched C₇-C₉ alcohol, more preferably with an ethylpentyl alcohol, a propylpentyl alcohol, an ethylhexyl alcohol, a propylhexyl alcohol, an ethylheptyl alcohol, a propylheptyl alcohol, more preferably with an ethylhexyl alcohol, preferably with 2-ethylhexyl alcohol or with 3-ethylhexyl alcohol, most particularly preferably with 2-ethylhexyl alcohol. So far as the rheology of the system is concerned and/or for reasons of availability, it is frequently desirable to use esters from acid mixtures.

In one embodiment, the at least one ester has a carbon chain distribution of the acid-derived component determined by gas chromatography (GC) according to ISO 5508 with carbon numbers in the ranges of from 0 to 2.00%, preferably in the range of from 0 to 1.00%, more preferably in the range of from 0 to 0.5% C_{6,} in the range of from 3.00% to 10.00%, preferably in the range of from 3.00 to 8.00%, more preferably in the range of from 4.00 to 7.00% C₈, in the range of from 3.00% to 10.00%, preferably in the range of from 3.00 to 9.00%, more preferably in the range of from 5.00 to 8.00% C₁₀, in the range of from 50.00% to 94.00%, preferably in the range of from 55.00 to 90.00%, more preferably in the range of from 60.00 to 85.00% C₁₂, in the range of from 0 to 25.00%, preferably in the range of from 5.00 to 20.00%, more preferably in the range of from 10.00 to 20.00% C₁₄, in the range of from 0 to 5.00%, preferably in the range of from 1.00 to 4.00%, more preferably in the range of from 2.00 to 4.00% C₁₆ and in the range of from 0 to 1.00%, preferably in the range of from 0.01 to 0.90%, more preferably in the range of from 0.1 to 0.6% C₁₈.

In another embodiment, the at least one ester has a carbon chain distribution of the acid-derived component determined by gas chromatography (GC) according to ISO 5508 with carbon numbers in the range of from 0 to 2.00%, preferably in the range of from 0 to 1.00%, more preferably in the range of from 0 to 0.5% C₆, in the range of from 0 to 10.00%, preferably in the range of from 1.00 to 7.00%, more preferably in the range of from 2.00 to 5.00% C₈, in the range of from 0 to 10.00%, preferably in the range of from 1.00 to 7.00%, more preferably in the range of from 2.00 to 5.00% C₁₀, in the range of from 50.00% to 95.00%, preferably in the range of from 60.00 to 90.00%, more preferably in the range of from 65.00 to 85.00 C₁₂, in the range of from 5.00% to 35.00%, preferably in the range of from 8.00 to 30.00%, more preferably in the range of from 10.00 to 25.00% C₁₄, in the range of from 0 to 5.00%, preferably in the range of from 1.00 to 4.00%, more preferably in the range of from 2.00 to 4.00% C₁₆ and in the range of from 0 to 1.00%, preferably in the range of from 0.01 to 0.90%, more preferably in the range of from 0.1 to 0.6% C₁₈.

The at least one ester used according to embodiments of the invention has at least one, preferably at least two, more preferably at least three, yet more preferably at least four, more preferably at least five, more preferably all of the following properties, in any combination with each other:
α1) a viscosity determined according to ASTM D2983 using a Brookfield RVT viscometer (Brookfield, RVT viscosity) at temperatures of 0° C. to 5° C. of not more than 50 mPa·s, preferably of not more than 10 mPa·s and preferably in the range of from about 2.0 to 5.0 mPa·s, more preferably in the range of from about 2.5 to 4.5 mPa·s, yet more preferably in the range of from about 2.7 to 4.0 mPa·s;
α2) an acid value determined according to ISO 660 in a range of from 0 to 2.0 mg KOH/g, preferably in a range of from 0001 to 1.8 mg KOH/g, preferably in a range of from 0.01 to 1.5 mg KOH/g, preferably in a range of from 0.05 to 1.0 mg KOH/g;
α3) a hydroxyl value determined according to DIN 53240 in a range from 0 to 1.5 mg KOH/g, preferably in a range from 0 to 1.0 mg KOH/g, more preferably in a range from 0 to 0.8 mg KOH/g;
α4) biodegradability in seawater measured according to OECD Guideline for Testing of Chemicals, No. 306, adopted 17 Jul. 1992, in the range of from 90% to 100%, preferably in the range of from 92% to 100%, more preferably in the range of from 95% to 100%.
α5) non-toxicity measured by the 96 hour LC50 Mysid shrimp acute toxicity bioassay test result of greater than 800,000, preferably of greater than 900,000, more preferably of greater than 1,000,000 and most preferably of greater than 1,100,000.
α6) a flashpoint measured according to ASTM D93 of above 150° C., more preferably of above 160° C., even more preferably of above 170° C., yet more preferably above 175° C., more preferably in a range from 175° C. to 200° C., even more preferably in a range from 177° C. to 182° C.

It is also possible according to a further embodiment of the composition according to the invention that the at least one ester is a mixture of at least two esters selected from any of the esters described above.

Appendix B

Drilling Mud Compositions

The composition according to embodiments of the invention may comprise only, or predominantly, starting materials of natural origin, but is by no means limited to starting materials of natural origin. Both on the alcohol side and on the carboxylic acid side, the starting materials may be of natural origin or may be partly or completely of synthetic origin. Starting materials of natural origin are advantageous in their proven lower toxicological values, their ready degradability and their ready accessibility. The ultimately desired destruction, preferably natural destruction, of the used composition is favored if esters of the type described herein are both aerobically and anaerobically degradable.

The water or aqueous phase of the drilling mud composition according to embodiments of the invention is a salt solution, preferably a saturated salt solution, preferably a saturated solution of CaCl₂ and/or KCl.

Multi-substance mixtures further comprising one or more additives may be added. In principle, any mixtures can be used provided that they fulfill the basic rheological requirements for drilling fluids, in particular for invert-drilling fluids.

Additives according to embodiments of the invention can be any additives which are commonly used in drilling compositions and which are known to the skilled person. At least one additive is selected from the group consisting of weighting agents, fluid loss additives, pH modifiers such as, for example, alkali reserves, viscosity modifiers, filtration control agents, emulsifiers, salts, wetting agents, dispersants.

Weighting agents suitable for use in drilling compositions are well known to the skilled person. Weighting agents suitable according to the invention are preferably water-insoluble weighting agents such as barite, calcite, mullite, galena, hematite, manganese oxides, iron oxides, or combinations of these, or water-soluble weighting agents such as water soluble salts of zinc, iron, barium, calcium or combinations of these and similar compounds. Further examples of suitable weighting agents are Fe₂O₃, MnO₄ and CaCO₃. The weighting agent preferred according to the invention to establish the necessary pressure equalization is barite, which comprises predominantly barium sulphate, which is added in quantities adapted to the particular conditions to be expected in the well. For example, it is possible by addition of barite to increase the specific gravity of the drilling mud to values of up to 2.5 and preferably in the range of from 1.3 to 1.6.

Fluid loss additives can be used. Organophilic lignite is used as a fluid loss additive and, hence, for forming an impervious coating in the form of a substantially liquid-impermeable film over the walls of the well. Suitable quantities are, for example, in the range of from 15 to 20 lb/bbl or in the range of from 20 to 60% by weight, preferably in a range of from 30 to 50% by weight, based on the ester phase.

Agents which modify the pH of the composition may be added. Examples are given in EP 382 070 A1. The teaching of this earlier application is based on the concept of using a further additive in ester-based invert drilling fluids, which is suited to keeping the desired rheological data of the drilling fluid in the required range even when, in use, increasingly large amounts of free carboxylic acids are formed by partial ester hydrolysis. These liberated carboxylic acids should not only be trapped in a harmless form, it should moreover be possible to reform these free carboxylic acids, preferably into valuable components with stabilizing or emulsifying properties for the whole system. According to this teaching, alkaline amine compounds of marked oleophilic nature and at best limited water solubility, which are capable of forming salts with carboxylic acids, can be used as additives in the oil phase. The oleophilic amine compounds can at the same time be used at least in part as alkali reserves in the invert drilling fluid, they can however also be used in combination with conventional alkali reserves, particularly together with lime. The use of oleophilic amine compounds which are at least largely free from aromatic constituents is preferred. In particular, optionally olefin unsaturated aliphatic, cycloaliphatic and/or heterocyclic oleophilic basic amine compounds, can be considered, which contain one or more N-groups capable of forming salts with carboxylic acids. In an embodiment, the water-solubility of these amine compounds at room temperature is at most about 5% by weight and is most preferably below 1% by weight.

Typical examples of such amine compounds are primary, secondary and/or tertiary amines, which are at least predominantly water-insoluble, and which can also to a limited extent be alkoxylated and/or substituted particularly with hydroxyl groups. Further examples are corresponding aminoamides and/or heterocycles containing nitrogen as ring constituent. For example, basic amine compounds are suitable which have at least one long-chain hydrocarbon radical with preferably 8 to 36 carbon atoms, particularly with 10 to 24 carbon atoms, which can also be olefin mono- or poly-unsaturated. The oleophilic basic amine compounds can be added to the drilling fluid in amounts of up to about 10 lb/bbl, preferably in amounts up to about 5 lb/bbl and particularly in the range of about 0.1 to 2 lb/bbl. It has emerged that the use of such oleophilic basic amine compounds can effectively prevent thickening of the mud system, which has previously been attributed to a disturbance in the W/O invert system and also to the formation of free carboxylic acids by ester hydrolysis.

One limitation associated with the use of the esters according to the third and fourth sub-classes arises out of the difficulty that, in principle, the carboxylic acid esters are vulnerable to hydrolysis.

In embodiments, but particularly those using the third and fourth sub-classes, strong hydrophilic bases of inorganic and/or organic nature, such as alkali metal hydroxides or strongly hydrophilic amines such as diethanolamine and/or triethanolamine, are not used in significant quantities as alkali reserve. Lime (calcium hydroxide) is often added as the alkali reserve, more especially for protection against inrushes of acidic gases such as CO₂ and/or H₂S into the drilling fluid and hence for protection against corrosion. An addition of lime such as this may be used as the alkali reserve in accordance with the invention. However, it is preferred to ensure that only comparatively small quantities of this alkaline component are incorporated. In a preferred embodiment of the invention, the maximum addition of lime is of the order of 2 lb/bbl (lime/drilling composition), and it may be preferred to work with lime contents in the drilling mud slightly below this, e.g., therefore from about 0.5 to about 1.8 lb/bbl (lime/drilling fluid). Other known alkali reserves can be used in addition to or in place of the lime. The less basic metal oxides, such as zinc oxide, should particularly be mentioned here. Even when these acid traps are used, care is still taken that the amounts used are not too large, so as to prevent undesired premature ageing of the drilling fluid, associated with an increase in viscosity and therefore a deterioration in the rheological properties. As discussed the process substantially prevents, or at least restricts, the formation of undesirable amounts of highly active O/W emulsifiers, so that the good rheological properties are maintained for a sufficiently long time in use even when there is normal ageing.

Viscosity modifiers suitable for use in drilling compositions are well known to the skilled person. Viscosity modifiers can be viscosifiers (also known as structure building agents or thickeners) which increase viscosity, or deflocculants which decrease viscosity, whereby in the present invention viscosifiers are preferred. Viscosifiers can be selected from organic or inorganic thickeners, for example, xanthan gum, guar gum, glycol, carboxymethylcellulose, polyanionic cellulose or starch. Deflocculants can be selected from anionic polyelectrolytes such as acrylates, polyphosphates, lignosulfonates or tannic acid derivatives such as Quebracho. A viscosifier preferred according to the invention is a cation-modified finely particulate bentonite, which can be used particularly in amounts of about 8 to 10 lb/bbl (pounds per barrel) or from about 1 to about 60 wt. %, preferably from about 2 to about 55% by weight, based on the total weight of the composition.

Emulsifiers which are used according to embodiments of the invention are systems which are capable of forming water in oil (W/O) emulsions. In particular, selected oleophilic fatty acids or salts thereof, for example, those based on amidoamine compounds, in particular polyaminated fatty acids, can be considered. Examples of these are described in U.S. Pat. No. 4,374,737 and the literature cited therein. Particularly preferred emulsifiers are reaction products of a polyamine with a fatty acid or fatty acid anhydride to give a fatty amide, which is subsequently reacted with an anhydride, preferably maleic acid anhydride, acrylic acid anhydride or fumaric acid anhydride, most preferably maleic acid anhydride, in the presence of at least one crosslinker. Examples of these are described in U.S. Pat. No. 4,658,036 and the literature cited therein, whose disclosures are hereby incorporated by reference. A particularly suitable type of emulsifier is the product sold by Halliburton (Baroid Fluid Services) under the brand name “EZ-MUL®”.

Emulsifiers of the type in question are sold commercially as highly concentrated active-substance preparations and in one embodiment can, for example, be used in amounts of about 20 to 80% by weight, particularly in amounts of about 30 to 70% by weight, based on the organic phase. It is, however, preferred that emulsifiers are used in amounts in the range from about 0.5 wt. % to about 15 wt. %, preferably in amounts in the range from about 0.5 wt. % to about 10 wt. %, more preferably in amounts in the range from about 1 wt. % to about 8 wt. %, more preferably in amounts in the range from about 1 wt. % to about 6 wt. %, based on the organic phase.

The aforementioned emulsifiers or emulsifier systems can optionally also be used to improve the oil wettability of the inorganic weighting materials. In addition to the aminoamides already discussed, alkyl benzenesulfonates and imidazoline compounds are further examples. Additional information regarding these can be found in the following publications: GB 2 158 437, EP 229 912 and DE 32 47 123, whose disclosures are hereby incorporated herein by reference in their entirety.

The dispersed aqueous phase in the composition, which is preferably in the form of an invert drilling fluid, is preferably loaded with soluble salts. At least one salt is selected from the group consisting of metal halides, particularly preferably alkali metal or alkaline earth metal halides. Calcium chloride and/or potassium chloride is used in embodiments of the invention and saturation of the aqueous phase with the soluble salt at room temperature is preferred.

In embodiments comprising water or aqueous phase, the composition is in the form of an emulsion, preferably in the form of a nanoemulsion or a microemulsion, preferably in the form of a water-in-oil emulsion with number average droplet sizes smaller than 1000 μm, preferably in the range from about 5 nm to about 1000 μm, preferably in the range from 10 nm to 850 μm, more preferably in the range from 20 nm to 700 μm, more preferably in the range from 50 nm to 500 μm. The terms “microemulsion” and “nanoemulsion” according to the invention are used to refer to emulsions with droplet sizes in the micrometer and nonometer ranges respectively, whereby there is a certain amount of overlap between the two ranges and thus the two terms. According to some definitions in the prior art, microemulsions are generally considered to form spontaneously on combination of the emulsion components, whereas the formation of nanoemulsions is generally considered to require input of energy, for example in the form of homogenization, in particular high pressure homogenization.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

1. A drilling fluid comprising:
an organic phase comprising between about 20 wt. % to about 95 wt. % of at least one saturated hydrocarbon based on the total weight of the organic phase; and
about 5 wt. % of ester based on the total weight of the organic phase.

2-8. (canceled)
